(19) United States
(12) Patent Application Publication
(10) Pub. No.: US 2012/0144607 A1
(43) Pub. Date: Jun. 14, 2012

(54) Self cleaning gutter system

(76) Inventor: Roland S. Johnson, Mt. Laurel, NJ (US)

(21) Appl. No.: 12/924,414

(22) Filed: Dec. 10, 2010

(51) Int. Cl. B08B 9/00

(52) U.S. Cl. 15/104.05

(57) ABSTRACT

This is new design assembly consisting of two brackets with a round tube, that is mounted on to the roof fascia, the bracket with a single one sided round tube is mounted at the far end of the fascia, and the bracket with the double sided tube is mounted on the fascia approx. 10 feet apart. Using the hole in the new end caps install the gutter assembly over the round tube on the bracket so that it rotates freely. Install a rain cover over the bracket. The pin is then removed from the bracket and the gutter assembly rotates from a horizontal location to a down position to clean out leaves and debris. After cleaning the gutter is rotated back to its original horizontal location and the pin is reinserted. The rain water will flow trough the bracket tube and out the downspout.

### DRAWINGS

FIG. 11s a side elevation showing bracket 27, including 29, 30, 20, 34, 35

FIG. 2 Is a top view showing bracket 26, 27, mounted at the roof fascia including 28, 29, 30, 33, 32, 31, 22

FIG. 3 Is a side view showing bracket 26, 27, mounted at the roof fascia including 28, 29, 30, 32, 33, 38, 39,

FIG. 4 Is a front view showing bracket 27, including 20, 23, 24, 27, 30

FIG. 5 Is a side view section showing bracket 27 thereof.

FIG. 6 Is a top view showing bracket 27 thereof

FIG. 7 Is a front view showing gutter end cap 21

FIG. 8 Is a side view section end cap 21 thereof

FIG. 9 Is a top view end cap 21 thereof

FIG. 10 Is a perspective view of the rain cover 10 Alum. sheet

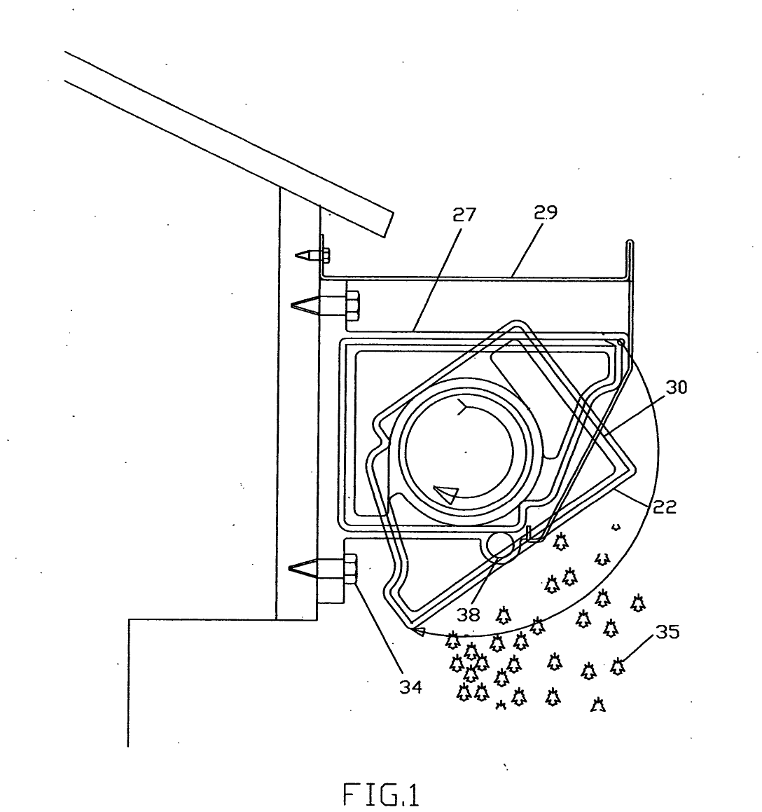

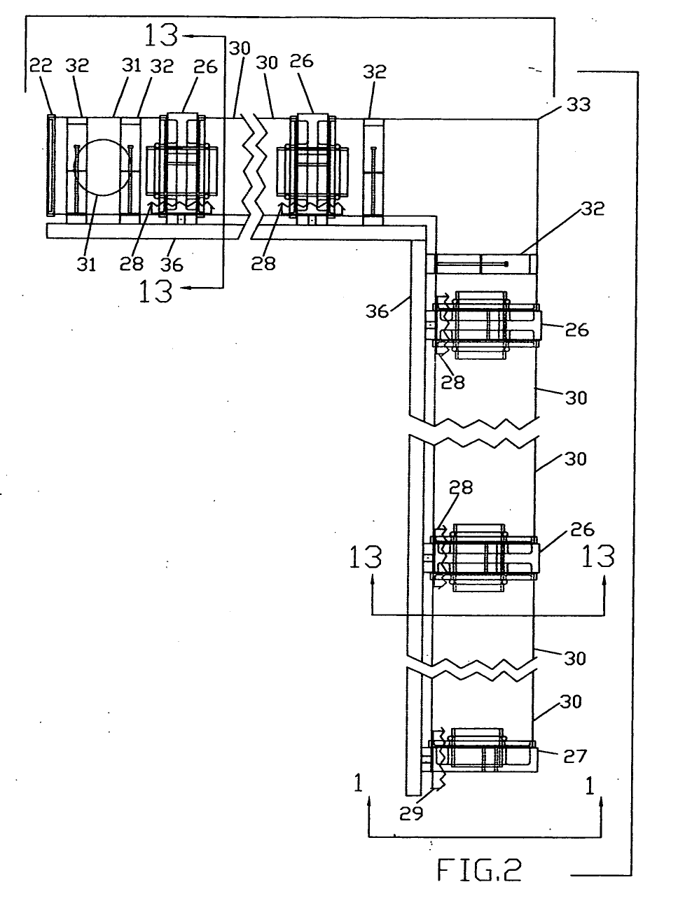

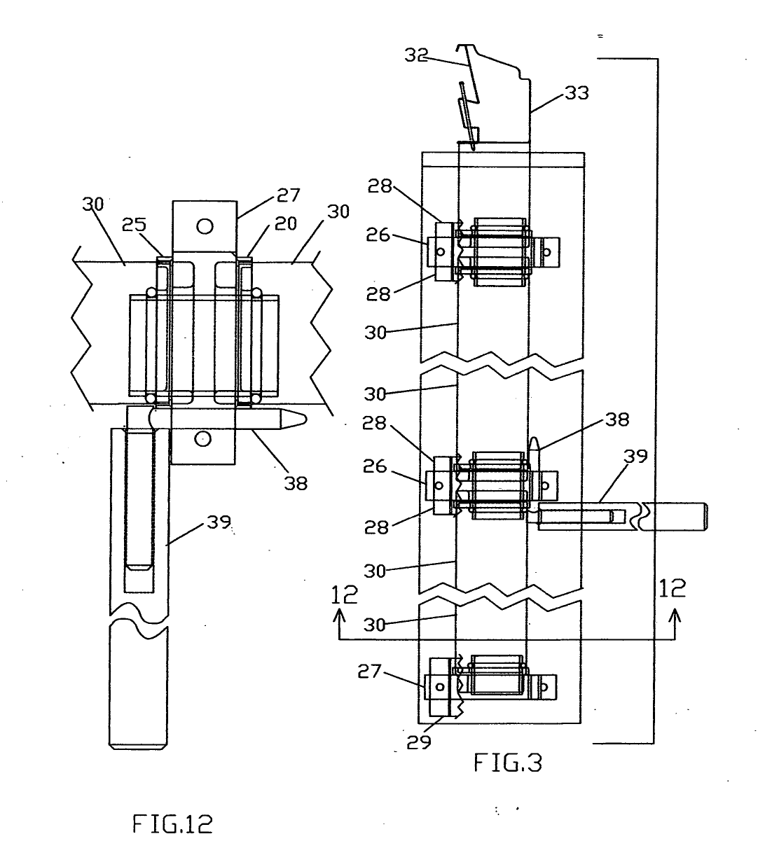

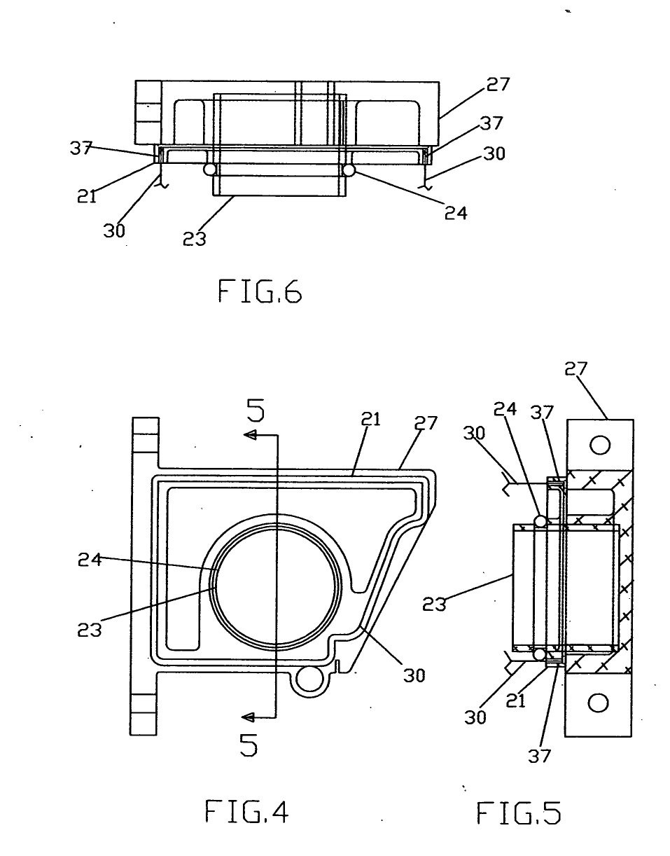

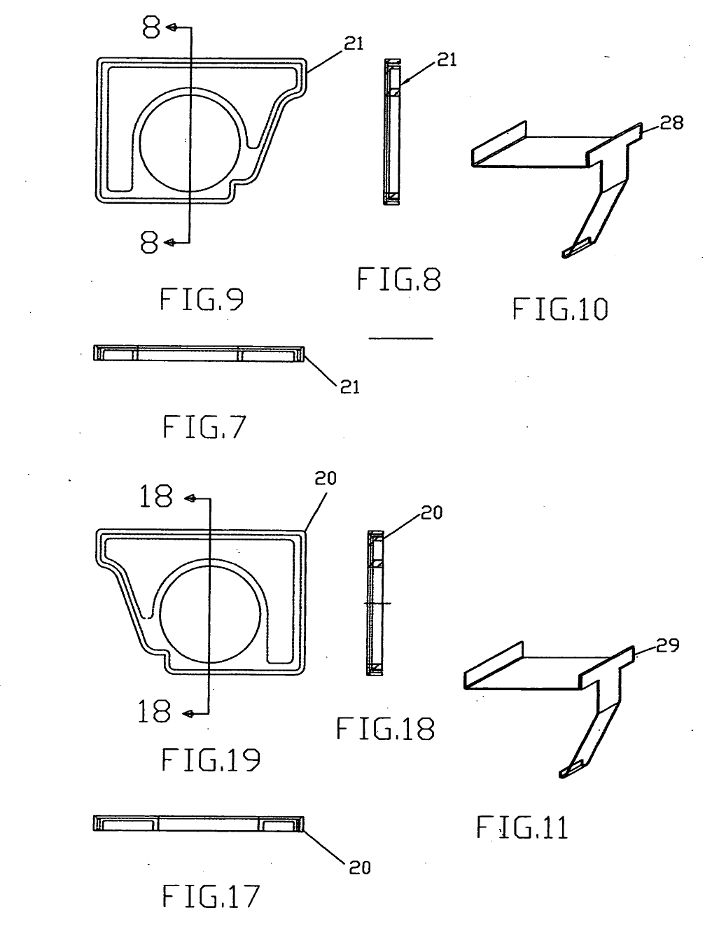

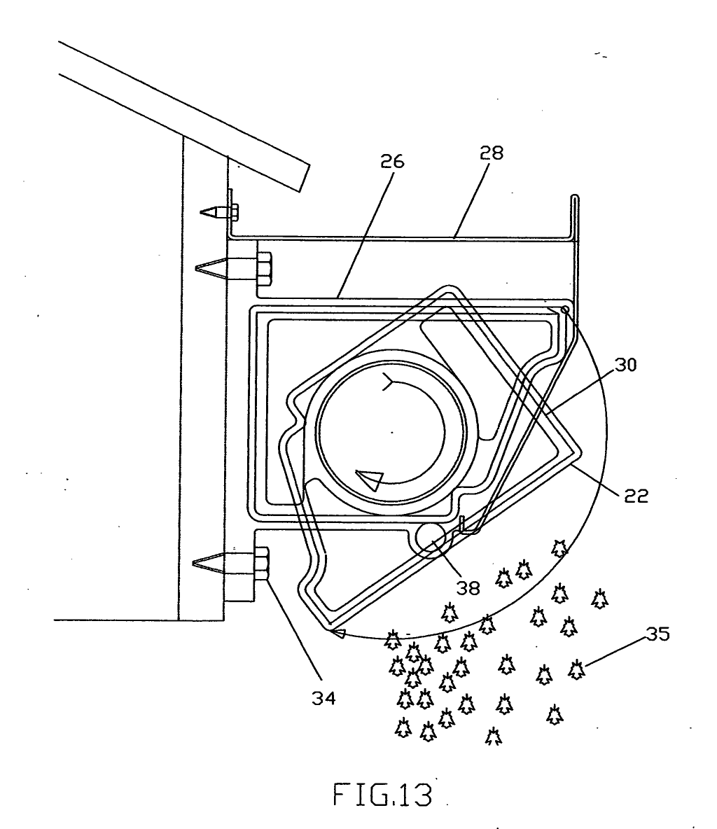

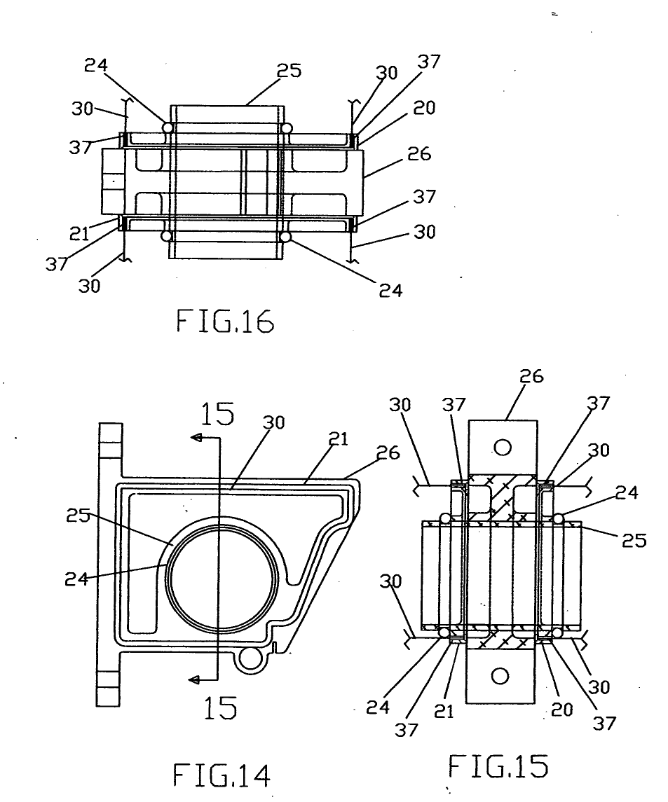

FIG. 11 Is a perspective view of the rain cover 11 Alum. sheet

FIG. 12 View showing pin 38 in the bracket 26 and 27 Including 20, 25, 30, 38, 39

FIG. 13 Is a side elevation showing bracket 26 including 28, 30, 22, 34, 35

FIG. 14 Is a front view of the bracket 26 including 21, 24, 25

FIG. 15 Is a side view section of the bracket 26 including 20, 21, 24, 25, 30, 37

FIG. 16 Is a top view of bracket 26 thereof

FIG. 17 Is a front view of gutter end cap 20.

FIG. 18 Is a side view section of gutter end cap 20

FIG. 19 Is a top view of gutter end cap 20

### REFERENCE NUMBERS

21 gutter end cap new
22 gutter end cap
23 round tube new
24 ‘o ring new
25 round tube new
26 gutter bracket new
27 gutter bracket new
28 rain cover guard new
29 rain cover guard new
30 gutter
31 gutter end with drop outlet
32 hidden gutter hanger
33 gutter inside corner
34 screws new
35 leaves and debris
36 roof fascia
37 gutter seam sealer new
38 pin new
39 pin extension new

### SPECIFICATION

FIG. 1 Side view of the bracket 27 mounted with screws 34 on to the roof fascia with the rain cover 29 being attached to the lower part of the bracket and mounted on to the roof fascia. Showing end cap 20, gutter 30, the hole in the bottom of the bracket is for pin 38, Standing at the ground level remove the pin 38 from the hole in the bracket and then rotate gutter assembly from a horizontal location to a tilted down position to clean out leaves and debris, after cleaning return gutter assembly to its horizontal location and reinsert pin 38 trough the hole in the bracket the rain water will flow trough the tube and downspout.

FIG. 2 A top view of the bracket 26 and 25 assembly mounted to the roof fascia approx. 10 feet apart including the rain cover 28 and 29, gutter 30, end drop 31, gutter outside corner 33 are attached to the end cap 20 and 21 on the bracket 26 and 27. Hanger 32 is attached to the roof fascia included with gutter end drop 31, gutter outside corner 33 and end cap 22.

FIG. 3 Is aside view showing bracket 26 and 27 assembly attached to the roof fascia approx. 10 feet apart including the rain cover 28 and 29, gutter 30, gutter corner 33 are attached to the end cap 20 and 21 on the bracket 26 and 27 Hanger 32 mounted to the roof fascia included with the gutter outside corner 33, showing pin 28 and 29 being inserted into bracket 26 and 27.

FIG. 4 A front view assembly of the bracket 27 alum. material, showing round tube 23, end cap 20, seal ring 24 and gutter 30.

FIG. 5 Is a section assembly of the bracket 27 with round tube 23 aluminum material, showing end cap 20 attached to the edge of gutter 30 and secured with gutter seam sealer, install 20 and 30 as an assembly over the tube 23 and secure with seal ring 23

FIG. 6 Is a top view of the bracket 27 thereof.

FIG. 7 Is a front view of the end cap 21 having a flanged diameter hole for use to fit over the tube 23 and 25 to rotate freely. The outer edge of end cap 21 have a slot for use to install gutter 30 and secure it with gutter seam sealer 37.

FIG. 8 Is a side view section thereof.

FIG. 9 Is a top view thereof.

FIG. 11A perspective view of the rain cover 29 alum.

FIG. 12 Shows the bracket 27 and pin 37 held against the end cap 20 and 25 to hold the assembly at its horizontal location when not tilted to a down position for cleaning.

FIG. 13 Side view of the bracket 26 mounted with screws 34 on to the roof fascia with the rain cover 28 being attached lower part of the bracket and mounted on to the roof fascia. Showing end cap 21, gutter 30 including the hole for pin 38. Standing at the ground level remove the pin 38 from the hole in the bracket, rotate the gutter assembly from a horizontal location to a tilted down position to clean out leaves and debris, after cleaning return gutter assembly to its horizontal location and reinsert 38 trough the hole in the bracket and the rain water will flow trough the tube opening and out the downspout.

FIG. 14 A front view assembly of bracket 26 aluminum, a round tube 25, end cap 21, seal ring 24 and gutter 30.

FIG. 15 Is a section assembly of the bracket 26 aluminum with a press fit round tube 25, showing end cap 20 and 21 installed over and around the tube 23 and 25 for use to rotate gutter assembly freely, attached gutter 30 with the end cap 20 and 21 and secure with gutter seam sealer.

FIG. 16 Is a top view of the bracket 26 thereof.

FIG. 17 Is a front view of end cap 20 aluminum having a flanged diameter hole to fit over the round tube 23 and 25, on the outer edge a slot is used to attached the gutter 30 outer edge with the end cap 21, secure with seam sealer 37

1. A new invention to clean out leaves and debris from The roof gutter, consist of a bracket with a round tube a rain cover and a pin as an assembly. It is mounted onto the roof fascia with the end caps attached to the roof gutter and rotated from a horizontal location to a down position to clean out the gutter. This is designed to eliminate using ladders to do this necessary home maintenance and reducing the possibility of falls and the resulting injures associated with this task.
